(19) United States
(12) Patent Application Publication
(10) Pub. No.: US 2004/0229036 A1
(43) Pub. Date: Nov. 18, 2004

(54) Domaines in a metal oxide matrix

(75) Inventors: Heiko Gottfried, Schoeneck (DE); Stipan Katusic, Kelkheim (DE); Michael Kraemer, Schoeneck (DE); Markus Pridoehl, Grosskrotzenburg (DE); Willibald Wombacher, Johannesberg (DE); Guido Zimmermann, Hanau (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/821,951

(22) Filed: Apr. 12, 2004

(30) Foreign Application Priority Data
Apr. 14, 2003 (DE) 103 17 067.7

(51) Int. Cl. B32B 23/02

(52) U.S. Cl. 428/401; 428/402; 428/565

(57) ABSTRACT

Composite powder with a matrix domain structure, in which

the matrix is a metal oxide and is present in the form of three-dimensional aggregates that have at least in one dimension a diameter of not more than 250 nm,

the domains consist of metal oxides and/or noble metals in the matrix of an individual metal oxide, wherein the domains consist of

at least two metal oxides or

at least two noble metals or

a mixture of at least one metal oxide and at least one noble metal, and

are nanoscale, and in which

the composite powder has a volume-specific surface of 60 to 1200 m²/cm³. The composite powder is produced by mixing the precursors of the oxides of the matrix and of the domains, corresponding to the subsequently desired ratio, with a gas mixture containing a combustible gas and oxygen and are reacted in a reactor consisting of a combustion zone and a reaction zone, and the hot gases and the solid products are cooled and then separated from the gases. It may be used as material for magnetic, electronic or optical applications.

The present invention relates to a composite powder with a matrix domain structure, and its production and use.

A problem in the production of nanoscale materials is the fact that the very small clusters, of an order of magnitude of ca. 1 to ca. 100 nm, that are originally formed during a reaction have a tendency to aggregate into larger units. The energy arising from the high surface/volume ratio is thereby reduced. The particular size-dependent electronic, optical, magnetic and chemical properties of these clusters are however also thereby reduced or completely eliminated.

The stabilisation of such clusters may be accomplished in a Polymeric, organic matrix. In this, the clusters are surrounded by the matrix and thereby prevented from. aggregating. The clusters coated in this way are also termed domains.

This is described for example in U.S. Pat. No. 4,474,866. A polymeric matrix, for example a synthetic ion-exchange resin, serves to stabilise nanoscale Fe₂O₃. For this, the resin is charged with iron ions, the iron ions are subsequently converted into Fe₂O₃, and the Fe₂O₃-charged resin is then dried. The disadvantage is that the resin as a rule still has to be ground in order to obtain a micronised powder. It is difficult to obtain a nanoscale powder by means of this grinding process. Further disadvantages are the low thermal stability of the organic matrix and the tedious production process. Further documents, in which the stabilisation of domains by means of an organic matrix is described include for example U.S. Pat. No. 4,101,435, U.S. Pat. No. 4,873,102 and U.S. Pat. No. 6,048,920.

Apart from organic materials, metal oxides or metalloid oxides may also serve as matrix material.

U.S. Pat. No. 5,316,699 describes the production of superparamagnetic domains in a dielectric matrix by a sol-gel process and the subsequent reductive treatment with hydrogen. The particles obtained have a network of interconnected pores in which the magnetic component is located. A disadvantage with the production by means of sol-gel processes is the as a rule tedious production of the particles, which may last up to several weeks, as well as the necessary post-treatment with hydrogen at uneconomically high temperatures. In addition the particles may contain impurities from the starting materials as well as byproducts and decomposition products from the further reaction steps.

Zachariah et al. (Nanostruct. Mater. 5, 383, 1995; J. Mater. Res. 14, 4661, 1999) describe the production of nanomaterials by flame oxidation. Silicon dioxide for example serves as matrix and the domains consist of iron oxides or titanium dioxide.

The prior art describes composite particles with matrix domain structures with metal oxides as domains and a matrix of an organic material or a metal oxide. In this connection, although the domains are of the nanoscale size, the matrix on the other hand is often significantly coarser, with the result that the desired nanoscale composite particles are obtained only by further grinding steps.

A powder that combines several of the particular properties of nanoscale powders would be desirable.

The object of the invention is accordingly to provide a composite powder with such a combination of properties. A further object of the invention is to provide a process for the production of these composite particles in which no further grinding steps are necessary in order to obtain nanoscale composite particles.

This object is achieved by a composite powder with a matrix domain structure, characterised in that

the matrix is a metal oxide and is present in the form of three-dimensional aggregates that have at least in one dimension a diameter of not more than 250 nm,

the domains consist of metal oxides and/or noble metals in the matrix of an individual metal oxide, wherein the domains consist of

at least two metal oxides or

at least two noble metals or

a mixture of at least one metal oxide and at least one noble metal, and

are nanoscale, and in which

the composite powder has a volume-specific surface of 60 to 1200 m²/cm³.

The term matrix domain structure is understood to denote structures of spatially separate domains in a matrix.

The term aggregate within the meaning of the invention is understood to denote three-dimensional structures of coalesced primary particles. Primary particles within the meaning of the invention are particles formed primarily in a flame in the oxidation reaction. On account of the high reaction temperatures, these are largely pore-free. Several aggregates may bind together to form agglomerates. These agglomerate can easily be re-separated. In contrast to this, as a rule it is not possible to break down the aggregates into the primary particles.

The aggregates may consist only of the oxide of the matrix or the oxide of one or more domains or their mixed forms in a matrix.

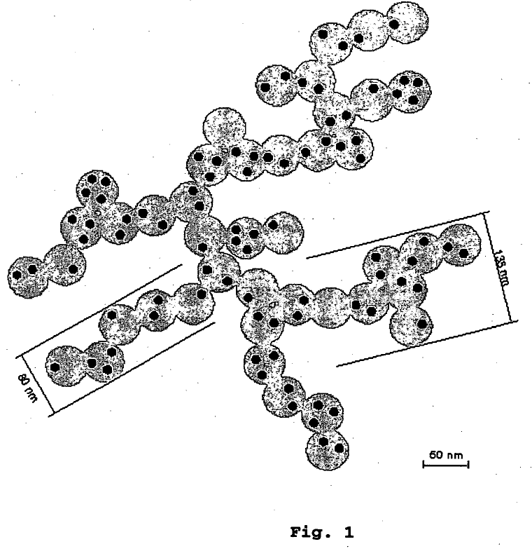

A primary particle may contain proportions of the oxide of the matrix and proportions of the oxide of a domain. The. three-dimensional aggregate structure of the powder according to the invention has at least in one spatial direction a circumference of not more than 250 nm (FIG. 1).

The volume-specific surface of the powder according to the invention is between 60 and 1200 m²/cm³. An advantageous embodiment may have a volume-specific surface between 100 and 800 g/cm³.

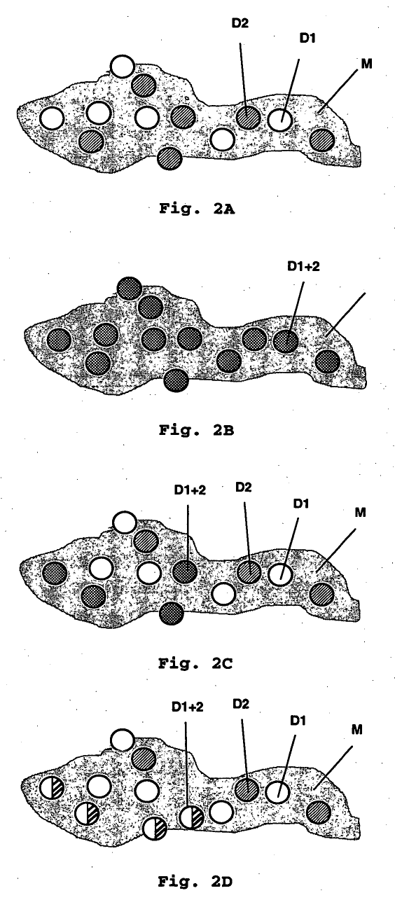

The domains of the powder according to the invention are nanoscale domains. These are understood to denote domains with a diameter of between 2 and 50 nm. These comprise at least two different metal oxides, two different noble metals, or a mixture of at least one metal oxide and at. least one noble metal. In this connection the different metal oxides or noble metals may be present in different domains or they may also be located within one domain. Mixed forms are also possible, in which a part of the metal oxides is present in different domains, whereas another part comprises domains with two metal oxides. The possible arrangements with two metal oxides as domains are shown by way of example in FIGS. 2A-D, in which: M=matrix, D1=domain consisting of metal oxide 1, D2=domain of metal oxide 2, D1+2=domain consisting of metal oxide 1 and metal oxide 2.

The metal oxides are then different if the metal oxides carry different metals, for example indium and tin.

Metalloid oxides such as for example silicon dioxide are also included as metal oxides within the meaning of the invention.

Furthermore, in the powder according to the invention the matrix and/or the domains may exist in amorphous form and/or crystalline form. Thus, the matrix or a domain may consist for example of amorphous silicon dioxide or of crystalline titanium dioxide.

The domains of the powder according to the invention may be completely or only partially enclosed by the surrounding matrix. Partially enclosed means that individual domains project from the surface of an aggregate. An embodiment may be preferred in which the domains are completely enclosed by the matrix. Thus, a powder according to the invention with crystalline titanium dioxide domains that are completely surrounded by an amorphous silicon dioxide matrix exhibits particularly advantageous UV-A and UV-B absorption with low photocatalytic activity.

The ratio, referred to the weight, of domains to matrix is not restricted so long as domains, i.e. spatially separate regions, are present. Powders with a ratio, referred to the weight, of domains to matrix of 1:99 to 90:10 may be preferred.

The matrix and the domains of the powder according to the invention may preferably comprise the oxides of Li, Na, K, Rb, Cs, Be, Mg, Ca, Sr, Ba, Sc, Y, La, Ce, Pr, Nd, Sm, Eu, Gd, Tb, Ti, Zr, Hf, V, Nb, Ta, Cr, Mo, W, Mn, Fe, Co,. Ni, Cu, Ag, Zn, Cd, Hg, B, Al, Ga, In, Te, Se, Tl, Si, Ge, Sn, Pb, P, As, Sb, Bi.

Particularly preferably the oxides may be oxides of Na, K, Mg, Ca, Y, Ce, Ti, Zr, V, Nb, Mo, W, Mn, Fe, Co, Ni, Ag, Zn, Al, In, Si, Sn, Sb, Bi.

Most particularly preferably the oxides may be oxides of Ti, Zr, Fe, Co, Ni, Zn, Al, In, Si, Sn.

In addition the domains may include the noble metals Au, Pt, Rh, Pd, Ru, Ir, Ag, Hg, Os, Re.

Particularly preferably, powders according to the invention may have a matrix consisting of the oxides of Ti, Al, Si, Zr and domains consisting of one or more oxides of Fe, Co, Ni, In, Sn.

A powder according to the invention may be preferred in which

the matrix is of silicon dioxide and

the domains consist of indium oxide, tin oxide and/or mixed metal oxide forms of indium and tin,

wherein the proportion of indium oxide, calculated as In₂O₃ and referred to the sum total of indium oxide and tin oxide, calculated as SnO₂, is from 80 to 98 wt. %, and

the proportion of silicon dioxide, referred to the sum total of silicon dioxide+indium oxide+tin oxide, is 10 to 99 wt. %.

In addition a powder according to the invention may be preferred in which

the matrix is of silicon dioxide and

the domains consist of manganese oxide, iron oxide and/or mixed metal oxide forms of iron/manganese,

wherein the proportion of iron oxide, calculated as Fe₂O₃ and referred to the sum total of iron oxide and manganese oxide, calculated as MnO, is 36 to 99 wt.%, and the proportion of silicon dioxide, referred to the sum total of silicon dioxide+iron oxide+manganese oxide, is 10 to 99 wt. %.

Furthermore a powder according to the invention may be preferred in which

the matrix is silicon dioxide,

the domains consist of manganese oxide, iron oxide, zinc oxide and/or mixed metal oxide forms of iron/manganese or iron/zinc or manganese/zinc,

with a proportion of iron oxide, calculated as Fe₂O₃, of 32 to 98 wt. %, manganese oxide, calculated as MnO, of 1 to 64 wt. %,

zinc oxide, calculated as ZnO, of 1 to 67 wt. %, in each case referred to the sum total of iron oxide, manganese oxide and zinc oxide, and

the proportion of silicon dioxide, referred to the sum total of silicon dioxide+iron oxide+manganese oxide+zinc oxide, is 10 to 99 wt. %.

Likewise, it may be advantageous within the context of the invention if the domains contain a mixed metal oxide structure in a proportion of at least 80 wt. %, preferably more than 90%. Such structures are shown in FIGS. 2C or 2D. Particularly advantageous interactions between the metal oxides of the domains may be produced in such structures.

The invention also provides a process for the production of the composite powder according to the invention, which is characterised in that the precursors of the oxides of the matrix and of the domains are mixed, corresponding to the subsequently desired ratio of the metal oxides, with a gas mixture containing a combustible gas and oxygen and are reacted in a reactor consisting of a combustion zone and a reaction zone, and the hot gases and the solid product are cooled and then separated from the gases.

Suitable as precursors are all compounds that can be oxidatively converted into their oxides under the conditions of the process according to the invention. Exceptions are noble metal compounds that are converted into the noble metals when used in the process according to the invention.

Suitable combustible gases may be hydrogen, methane, ethane, propane, butane, natural gas or mixtures of the aforementioned compounds, hydrogen being preferred. Oxygen is preferably used in the form of air or of air enriched with oxygen.

The product obtained by the process according to the invention may if necessary be purified after the separation of the gases by a heat treatment by means of gases moistened with water vapour.

The precursors of the oxides may be added in the form of aerosols and/or as vapour to the reactor.

In the case where the precursors of the oxides are added in the form of aerosols to the reactor, these may be produced separately or jointly.

The aerosols may be obtained from liquids, dispersions, emulsions and/or pulverulent solids in a gaseous atmosphere of the precursors and generated by ultrasound nebulisation through single-component or multicomponent nozzles. Usually the precursors are used in the form of aqueous, organic or aqueous-organic solutions. It is however also possible for example to use an aerosol in the form of metallic zinc.

Apart from aerosols, the precursors may also be added in the form of vapours to the reactor. In this case the vapours may be generated separately or jointly.

The vapours as well as the aerosols may in addition be added at one or more points within the reactor.

The precursors may be salts as well as organometallic compounds that carry the metal component of the desired metal oxide. The metals themselves, such as for example zinc, may also be used.

Suitable precursors may be metal powders, inorganic salts such as carbonates, nitrates, chlorides, nitrides, nitrites, hydrides, hydroxides or organic compounds with metals such as silanes, silicones, alkoxy compounds, salts of organic acids, organic complexes, alkyl compounds of precursors, halides, nitrates, organometallic compounds and/or the metal powders of Li, Na, K, Rb, Cs, Be, Mg, Ca, Sr, Ba, Sc, Y, La, Ce, Pr, Nd, Sm, Eu, Gd, Tb, Ti, Zr, Hf, V, Nb, Ta, Cr. Mo, W, Mn, Fe, Co, Ni, Cu, Ag, Zn, Cd, Hg, B, Al, Ga, In, Te, Se, Tl, Si, Ge, Sn, Pb, P, As, Sb, Bi, Au, Pt, Rh, Pd, Ru, Ir, Hg, Os, Re.

Particularly preferably nitrates, chlorides, alkoxy compounds and salts of organic acids may be used.

The process according to the invention may also include a post-treatment in a reducing atmosphere. This post-treatment may follow immediately after the combustion, without isolating the powder, or it may be performed after isolating and if necessary purifying the powder. The reducing atmosphere may be hydrogen, forming gas or ammonia, hydrogen being preferred. The post-treatment is normally carried out at temperatures between 20° and 1200° C. and under atmospheric pressure. Powders according to the invention with a smaller than stoichiometric value of oxygen may thereby be obtained.

The composite powder according to the invention comprises domains of nanoscale multi-component metal oxides and/or noble metals in an oxidic material. This leads to property combinations of the composite material that cannot be achieved with pure substances or physical mixtures of corresponding nanoparticles.

The present invention also provides for the use of the composite powder according to the invention for the production of ceramics, as material for magnetic, electronic or optical applications, in data storage media, as contrast agent in imaging processes, for polishing glass and metal surfaces; as catalyst or catalyst carrier, as function-imparting filler, as thickening agent, as flow auxiliary, as dispersion aid, as ferrofluid, as pigment and as coating agent.

### EXAMPLES

### Example 1

### Indium-Tin Oxide in a Silicon Dioxide Matrix

0.51 kg/hour of the matrix precursor SiCl₄ is vaporised at ca. 200° C. and fed together with 3.8 Nm³/hour of hydrogen as well as 16.4 Nm³/hour of air and 1 Nm³/hour of nitrogen into the reactor.

In addition an aerosol consisting of the domain precursors, which is obtained from an aqueous indium(III) chloride and tin(IV) chloride solution by means of a two-component nozzle, is introduced by means of a carrier gas (3 Nm³/hour of nitrogen) into the reactor. The aqueous solution contains 10.98 wt. % InCl₃ and 0.66 wt. % SnCl₄.

The homogeneously mixed gas-aerosol mixture flows into the reactor and burns there at an adiabatic combustion temperature of about 1200° C. and a residence time of about 50 msec.

The residence time is calculated from the quotient of the volume of the plant through which the mixture has flowed and the operating volume flow of the process gases at the adiabatic combustion temperature.

After the flame hydrolysis, in a known manner the reaction gases and the resultant silicon dioxide powder doped with indium-tin oxide are cooled and the solid is separated from the waste gas stream by means of a filter.

In a further step hydrochloric acid residues that are still adhering are removed from the powder by treatment with nitrogen containing water vapour.

The Examples 2 to 4 are carried out similarly to Example 1. In Example 2 the same precursors as in Example 1 are used, though in other ratios. In Example 3 iron chloride and zinc chloride in solution are used as domain precursors, and silicon tetrachloride in the form of vapour is used as matrix precursor. In Example 4 three domain precursors, namely iron, zinc and nickel chloride as solution are used, and as matrix precursor titanium tetrachloride in the form of vapour is used. In Example 5 zinc nitrate and palladium nitrate are used as domain precursors and aluminium nitrate in aqueous solution is used as matrix precursor, and are converted into an aerosol by means of ultrasound nebulisation and introduced by means of a carrier gas into the reactor. Example 6 is carried out similarly to Example 5. In Example 6. cerium(III) nitrate and palladium nitrate are used as domain precursors, and zirconyl nitrate in aqueous solution is used as matrix precursor. In Examples 7 and 8 silicon tetrachloride is used as matrix precursor and iron and manganese chlorides are used as matrix precursors, while in Example 8 zinc chloride is additionally used.

The starting substances and the reaction parameters are given in Table 1, and the analytical data of the resulting powders are given in Table 2.

TABLE 1
Starting substances/reaction parameters, Examples 1-8

| Example | | 1 | 2 | 3 | 4 | 5 | 6 | 7 | 8 |
|---|---|---|---|---|---|---|---|---|---|
| Hydrogen | Nm³/hr | 3.8 | 2.5 | 4.0 | 4.3 | 1.2 | 1.6 | 4.0 | 4.0 |
| Air | Nm³/hr | 16.4 | 14.8 | 14.1 | 15.2 | 4.05 | 4.70 | 14.1 | 14.1 |
| Oxygen | Nm³/hr | — | — | — | — | 0.35 | 0.7 | — | — |
| Nitrogen | Nm³/hr | 4.0 | 4.0 | 4.0 | 4.0 | 0.4 | — | 4.0 | 4.0 |
| Matrix | kg/hr | SiCl₄ | SiCl₄ | SiCl₄ | TiCl₄ | Al(NO₃)₃ | ZrO(NO₃)₂ | SiCl₄ | SiCl₄ |
| precursor | | 0.51 | 0.32 | 0.57 | 0.50 | 0.048 | 0.073 | 0.28 | 0.28 |
| Domain | kg/hr | InCl₃ | InCl₃ | FeCl₃ | FeCl₃ | Pd(NO₃)₂ | Pd(NO₃)₂ | FeCl₂ | FeCl₂ |
| Precursors | | 0.148 | 0.212 | 0.22 | 0.22 | 0.0046 | 0.0051 | 0.17 | 0.17 |
| | | SnCl₄ | SnCl₄ | ZnCl₂ | ZnCl₂ | Zn(NO₃)₂ | Ce(NO₃)₃ | MnCl₂ | MnCl₂ |
| | kg/hr | 0.0089 | 0.0604 | 0.03 | 0.095 | 0.015 | 0.0036 | 0.038 | 0.02 |
| | kg/hr | — | — | — | NiCl₂ | | | | ZnCl₂ |
| | | — | — | — | 0.019 | | | | 0.043 |
| Water* | kg/hr | 1.20 | 1.013 | 1.05 | 2.50 | 0.379 | 0.448 | 0.88 | 1.16 |
| Adiabatic temp. | ° C. | 1200 | 900 | 1400 | 900 | 905 | 1060 | 1400 | 1400 |
| Residence time | ms | ca. 50 | ca. 70 | ca. 50 | ca. 70 | ca. 800 | ca. 800 | ca. 50 | ca. 50 |

*Solution/dispersion of the domain precursors in water

TABLE 2
Analytical values of the powders according to the invention from Examples 1 to 8

| Example | | 1 | 2 | 3 | 4 | 5 | 6 | 7 | 8 |
|---|---|---|---|---|---|---|---|---|---|
| BET surface | m²/g | 142 | 165 | 55 | 60 | 31 | 56 | 65 | 49 |
| Volume-specific | m³/cm³ | 419 | 625 | 164 | 290 | 157 | 343 | 212 | 177 |
| surface | | | | | | | | | |
| Metal oxide matrix⁽*⁾ | wt. % | SiO₂ | SiO₂ | SiO₂ | TiO₂ | Al₂O₃ | ZrO₂ | SiO₂ | SiO₂ |
| | | 64.6 | 39.4 | 54.9 | 51.3 | 57.7 | 82.0 | 44.0 | 44.0 |
| Metal oxide 1 Domains⁽*⁾ | wt. % | In₂O₃ | In₂O₃ | Fe₂O₃⁽**⁾ | Fe₂O₃⁽**⁾ | Pd | Pd | Fe₂O₃⁽**⁾ | Fe₂O₃⁽**⁾ |
| | | 33.3 | 48.7 | 40.7 | 32.6 | 10.6 | 8.0 | 46.9 | 40.6 |
| Metal oxide 2 Domains⁽*⁾ | wt. % | SnO₂ | SnO₂ | ZnO | ZnO | ZnO | CeO₂ | MnO | MnO |
| | | 2.1 | 11.9 | 4.35 | 13.1 | 31.7 | 10.0 | 9.1 | 4.8 |
| Metal oxide 3 Domains⁽*⁾ | wt. % | — | — | — | NiO | — | — | — | ZnO |
| | | | | | 3.1 | | | | 10.6 |
| Mass ratio | | 94/6 | 80/20 | 90/10 | 67/27/6 | 25/75 | 44/56 | 84/16 | 74/8/18 |
| metal oxide 1:2(:3) | | | | | | | | | |
| Crystallize size | nm | 7.0 | 10 | 15.5 | n.b. | 24.0 | 30.0 | 17.3 | 17.8 |
| metal oxide 1 | | | | | | | | | |

⁽*⁾Semiquantitative X-ray fluorescence analysis;
⁽**⁾referred to Fe₂O₃; domains contain Fe₂O₃ and Fe₃O₄.

TEM Photographs

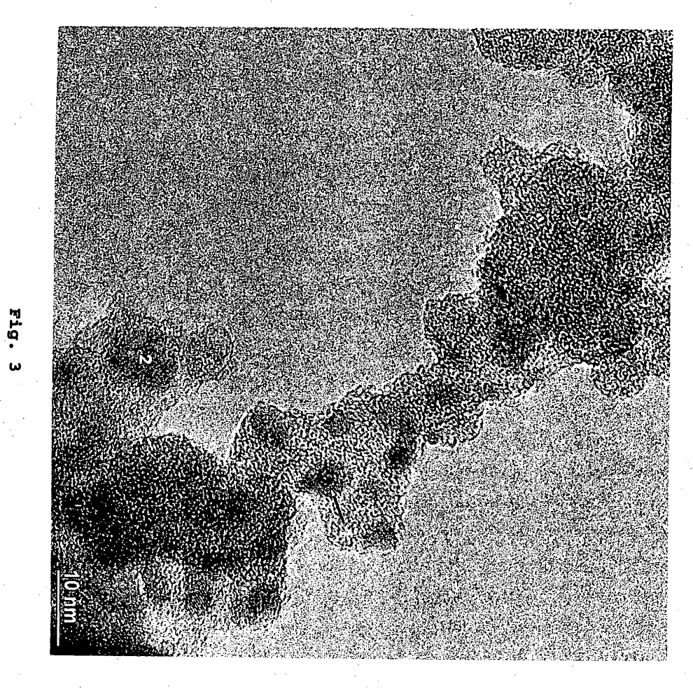

The TEM photographs of the particles from Examples 1 and 2 show an amorphous silicon dioxide matrix in which are embedded indium-tin oxide crystals with a crystallite size of 5 to 15 nm. FIG. 3 shows a TEM photograph of the powder from Example 1. In this, indium-tin oxide is shown as dark-coloured regions.

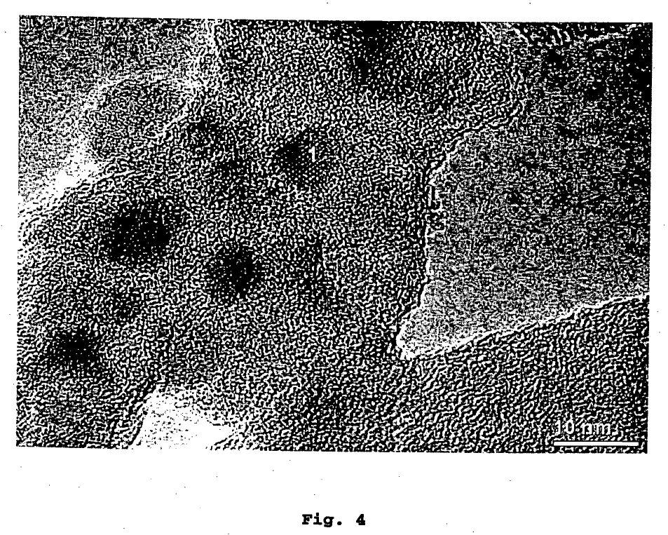

The TEM photograph of the powders from Example 3 shows an amorphous silicon dioxide matrix in which are embedded iron-zinc oxide crystals with a crystallite size of 5 to 30 nm (FIG. 4).

Energy-Dispersive X-Ray Analysis (EDX)

The EDX spectra of the powder from Example 1 show that the dark crystals contain exclusively indium and tin atoms.

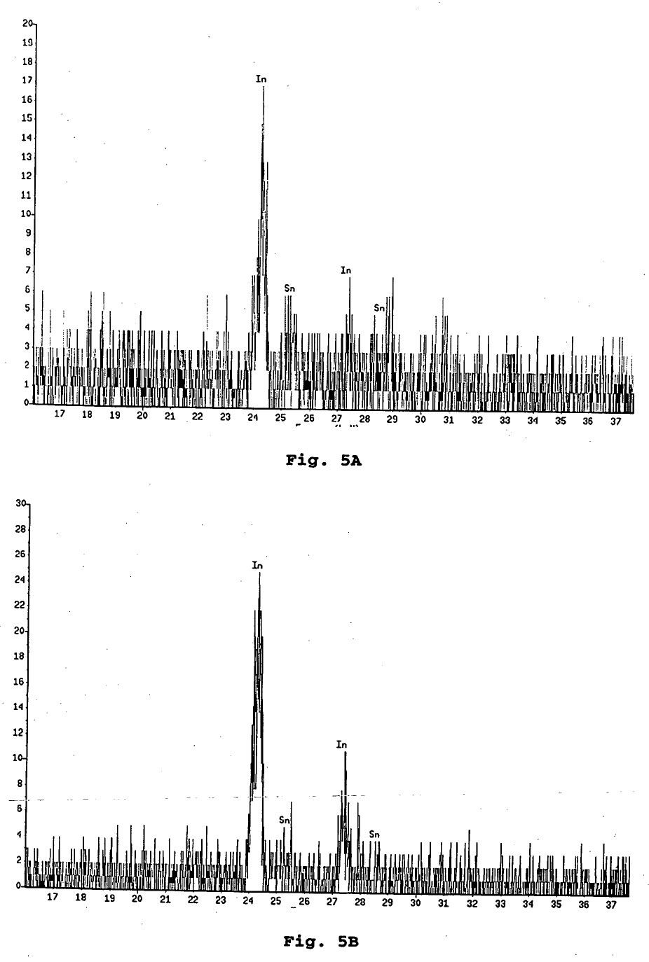

FIG. 5A shows an EDX spectrum of a domain from Example 1. The conversion of the atomic mass ratio of indium to tin of 94.6:5.4 to the corresponding oxides gives a mass ratio of indium oxide/tin oxide of 94.3:5.7. This is in good agreement with the overall value from the X-ray fluorescence analysis of indium oxide/tin oxide of 94.0:6.0

FIG. 5B shows an EDX spectrum of a further domain from Example 1. The atomic mass ratio of indium to tin of 99.5:0.5 shows that this domain consists almost exclusively of indium oxide.

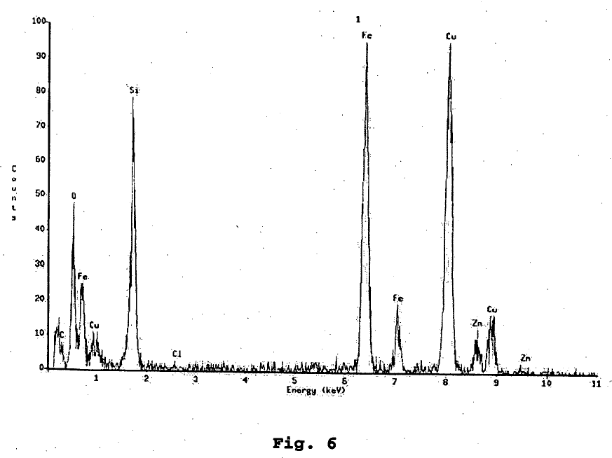

FIG. 6 shows the EDX spectrum of the powder from Example 3.

X-Ray Diffraction Diagrams (XRD)

The XRD spectra of the particles from Examples 1 and 2 show a clear signal at about 2theta=30.6°. This corresponds to the signal line of indium oxide (In₂O₃).

The XRD spectra of the particles from Example 3 show a clear signal at about 2theta=41.5°. This corresponds to the signal lines of magnetite (Fe₃O₄) and maghemite (gamma-Fe₂O₃, γ-Fe₂O₃).

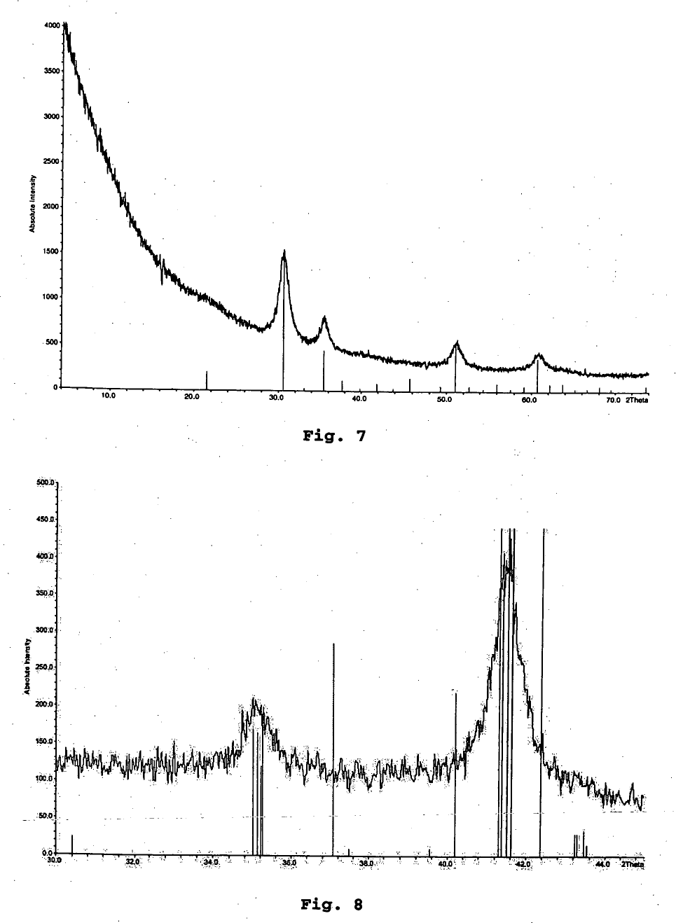

The background noise of the signals in Examples 1 to 3 is caused by the amorphous silicon dioxide. FIG. 7 shows the X-ray diffraction diagram of the particles from Example 1.

The Debye-Scherrer estimation gives a mean indium oxide crystallite size for the powder from Example 1 of 7.0 nm, from Example 2 of 10.2 nm, and a mean iron oxide. crystallite size for the powder from Example 3 of 15.5 nm. FIG. 8 shows the X-ray diffraction diagram of the particles from Example 3.

Lowering of the Curie Temperature

Examples 7 and 8 demonstrate convincingly the interaction within a domain. Thus, the Curie temperature of iron oxide is ca. 590° C. The powder of Example 7 has a Curie temperature of only ca. 490° C., and that of Example 8 a Curie temperature of only ca. 430° C.

This is probably attributable to the fact that a majority (greater than 90%) of the domains of the powders of Examples 7 and 8 exist in a ferritic structure. The XRD spectra of the powders do not exhibit any signals due to a manganese oxide or a zinc oxide.

The same comments also apply to the powders of Examples 1 and 2. There the majority (greater than 90%) of the domains have an indium-tin mixed metal oxide structure. This can be determined for example by HR-TEM in combination with EDX techniques.

The domains of the powders according to the invention thus predominantly exist, as a rule greater than 80%, in a form that most probably corresponds to the arrangements in FIGS. 2C and 2D.

1. Composite powder with a matrix domain structure, characterised in that
the matrix is a metal oxide and is present in the form of three-dimensional aggregates that have at least in one dimension a diameter of not more than 250 nm,
the domains consist of metal oxides and/or noble metals in the matrix of an individual metal oxide, wherein the domains consist of
at least two metal oxides or
at least two noble metals or
a mixture of at least one metal oxide and at least one noble metal, and
are nanoscale, and in which
the composite powder has a volume-specific surface of 60 to 1200 m²/cm³.

2. Composite powder with a matrix domain structure according to claim 1, characterised in that an individual domain contains one or more metal oxides and/or noble metals.

3. Composite powder with a matrix domain structure according to claim 1 or 2, characterised in that the matrix and the domains are present in an amorphous or crystalline form.

4. Composite powder with a matrix domain structure according to claims 1 to 3, characterised in that the domains are enclosed by the matrix.

5. Composite powder with a matrix domain structure according to claims 1 to 4, characterised in that the ratio, referred to the weight, of the sum total of the domains to the matrix is between 1:99 and 90:10.

6. Composite powder with a matrix domain structure according to claims 1 to 5, characterised in that the oxides of the matrix and of the domains comprise the oxides of Li, Na, K, Rb, Cs, Be, Mg, Ca, Sr, Ba, Sc, Y, La, Ce, Pr, Nd, Sm, Eu, Gd, Tb, Ti, Zr, Hf, V, Nb, Ta, Cr, Mo, W, Mn, Fe, Co, Ni, Cu, Ag, Zn, Cd, Hg, B, Al, Ga, In, Te, Se, Tl, Si, Ge, Sn, Pb, P, As, Sb or Bi.

7. Composite powder with a matrix domain structure according to claims 1 to 6, characterised in that the domains comprise the noble metals Au, Pt, Rh, Pd, Ru, Ir, Ag, Hg, Os or Re.

8. Composite powder with a matrix domain structure according to claim 1, characterised in that
the matrix is of silicon dioxide and
the domains consist of indium oxide, tin oxide and/or mixed metal oxide forms of indium and tin,
wherein the proportion of indium oxide, calculated as In₂O₃ and referred to the sum total of indium oxide and tin oxide, calculated as SnO₂, is from 80 to 98 wt. %, and
the proportion of silicon dioxide, referred to the sum total of silicon dioxide+indium oxide+tin oxide, is 10 to 99 wt. %.

9. Composite powder with a matrix domain structure according to claim 1, characterised in that
the matrix is of silicon dioxide and
the domains consist of manganese oxide, iron oxide and/or mixed metal oxide forms of iron/manganese,
wherein the proportion of iron oxide, calculated as Fe₂O₃ and referred to the sum total of iron oxide and manganese oxide, calculated as MnO, is 36 to 99 wt. %, and
the proportion of silicon dioxide, referred to the sum total of silicon dioxide+iron oxide+manganese oxide, is 10 to 99 wt. %.

10. Composite powder with a matrix domain structure according to claim 1, characterised in that
the matrix is silicon dioxide,
the domains consist of manganese oxide, iron oxide, zinc oxide and/or mixed metal oxide forms of iron/manganese or iron/zinc or manganese/zinc,
with a proportion of iron oxide, calculated as Fe₂O₃, of 32 to 98 wt. %, manganese oxide, calculated as MnO, of 1 to 64 wt. %,
zinc oxide, calculated as ZnO, of 1 to 67 wt. %, in each case referred to the sum total of iron oxide, manganese oxide and zinc oxide, and
the proportion of silicon dioxide, referred to the sum total of silicon dioxide+iron oxide+manganese oxide+zinc oxide, is 10 to 99 wt. %.

11. Composite powder with a matrix domain structure according to claims 1 to 10, characterised in that the domains have a mixed metal oxide structure in a proportion of at least 80%.

12. Process for the production of the composite powder according to claims 1 to 11, characterised in that the precursors of the oxides of the matrix and of the domains are mixed, corresponding to the subsequently desired ratio of the metal oxides, with a gas mixture containing a combustible gas and oxygen and are reacted in a reactor consisting of a combustion zone and a reaction zone, and the hot gases and the solid product are cooled and then separated from the gases.

13. Process according to claim 12, characterised in that after the separation of the gases the product undergoes for purposes of purification a heat treatment by means of gases moistened with water vapour.

14. Process according to claim 12 or 13, characterised in that the precursors are added in the form of aerosols and/or as vapour to the reactor.

15. Process according to claim 14, characterised in that the aerosols of the precursors are produced separately or jointly.

16. Process according to claim 15, characterised in that the aerosols of the precursors are obtained from liquids, dispersions, emulsions and/or pulverulent solids in a gaseous atmosphere.

17. Process according to claim 15 or 16, characterised in that the aerosols are produced by ultrasound nebulisation or by means of single-product or multi-product nozzles.

18. Process according to claim 14, characterised in that the vapours of the precursors are produced separately or jointly.

19. Process according to claims 12 to 18, characterised in that the aerosols and/or vapours are additionally added at one or more points to the reactor.

20. Process according to claims 12 to 19, characterised in that the precursors are halides, nitrates, organometallic compounds and/or the metal powders of Li, Na, K, Rb, Cs, Be, Mg, Ca, Sr, Ba, Sc, Y, La, Ce, Pr, Nd, Sm, Eu, Gd, Tb, Ti, Zr, Hf, V, Nb, Ta, Cr, Mo, W, Mn, Fe, Co, Ni, Cu, Ag, Zn, Cd, Hg, B, Al, Ga, In, Te, Se, Tl, Si, Ge, Sn, Pb, P, As, Sb, Bi, Au, Pt, Rh, Pd, Ru, Ir, Hg, Os or Re.

21. Process according to claims 12 to 20, characterised in that the product is treated in a reducing atmosphere before or after the purification.

22. Use of the composite powder according to claims 1 to 11 for the production of ceramics, as material for magnetic, electronic or optical applications, in data storage media, as contrast agent in imaging processes, for polishing glass and metal surfaces, as catalyst or catalyst carrier, as function-imparting filler, as thickening agent, as flow auxiliary, as dispersion aid, as ferrofluid, as pigment or as coating material.
